(19) United States
(12) Patent Application Publication
(10) Pub. No.: US 2025/0088888 A1
(43) Pub. Date: Mar. 13, 2025

(54) SYSTEM AND METHOD FOR DATA MONITORING FOR MOBILE DEVICE MANAGEMENT

(71) Applicant: SOTI Inc., Mississauga (CA)

(72) Inventor: Carl RODRIGUES, Mississauga (CA)

(21) Appl. No.: 18/754,936

(22) Filed: Jun. 26, 2024

Related U.S. Application Data
(60) Provisional application No. 63/581,375, filed on Sep. 8, 2023.

(51) Int. Cl. H04W 24/10; H04W 16/18

(52) U.S. Cl. CPC H04W 24/10; H04W 16/18

(57) ABSTRACT

A system and method of data monitoring for mobile device management. The method includes: determining a set of data monitors, each data monitor includes a monitored property and a data monitor trigger; communicating the data monitors to mobile devices; receiving monitored data from the mobile devices based on the data monitor triggers; and analyzing the monitored data to display status information based on the monitored data. The system includes: a processor and a memory, the memory includes computer code that, when executed on the processor cause the system to implement: an agent server configured to determine a set of data monitors, each data monitor including a monitored property and a data monitor trigger, wherein the agent server is configured to: communicate the data monitors to mobile devices; receive monitored data from the mobile devices; and analyze the monitored data to display status information based on the monitored data.

### RELATED APPLICATIONS

The present disclosure claims priority to U.S. Provisional Patent Application No. 63/581,375, filed Sep. 8, 2024, which is hereby incorporated herein in its entirety.

### FIELD

The present disclosure relates generally to a system and method for data monitoring and remote telemetry for mobile device management and, in particular, to a system and method for acquiring, managing, and monitoring data related to mobile devices.

### BACKGROUND

In the field of computer networks, mobile device management involves various issues that are not present in fixed networks. Mobile phones/computers and, generally, Internet of things (IoT) devices, including tags or the like, that are mobile (referred to collectively as “mobile devices”) can encounter various different issues, including varying signal strength, rapid and numerous switches between various networks, lower data capacities, both for storage and for network communications, limited CPU performance, and battery health impacts on performance. Mobile devices are also typically more vulnerable to security threats as mobile devices can be exposed to unprotected WiFi networks more often. In comparison to fixed devices, mobile devices also tend to be lost or stolen more often.

It will be understood that one or more of these issues may require information technology support raised by a user and an IT support person may be tasked with diagnosing and resolving the issue. While it is possible for various types of data to be saved by a mobile device to assist with diagnosis, the transmission of such data to an IT support person can require network bandwidth and can also consume a large amount of storage both on the device and at the IT support location. The problem becomes more complex when trying to diagnose multiple mobile devices being managed by the organization. Further, in at least some circumstances, the diagnosis may benefit from having information/data from a plurality of mobile devices.

As such, there is a need for an improved system and method for data monitoring for mobile device management.

### SUMMARY

According to one aspect herein, there is provided a method of data monitoring for mobile device management, the method including: determining a set of data monitors, where each data monitor in the set may include a monitored property and a data monitor trigger for the monitored property; communicating the set of data monitors to a plurality of mobile devices; receiving monitored data associated with the monitored properties from the plurality of mobile devices based on the data monitor triggers; and analyzing the monitored data to display status information based on the monitored data.

In some cases, the method may further include: automatically controlling mobile device settings based on the monitored data.

In some cases, the method may further include selecting a subset of the plurality of mobile devices to be monitored.

In some cases, the method may further include showing at least some of the plurality of mobile devices displayed on a map or in a tabular form. In this case, the displayed map may include an indoor or an outdoor map.

In some cases, the data monitor trigger may include determining if the monitored data for the monitored property has changed more than a configured threshold value or beyond a configured threshold as defined by a set of rules. In this case, the configured threshold value or configured threshold as defined by a set of rules is adapted based on a status of the mobile device.

In some cases, the method may further include: monitoring for events received from the plurality of mobile devices; and analyzing the events to: display the events together with the monitored data; and, optionally, automatically control mobile device settings or applications based on the events. In this case, the events may include at least one of: opening of a disallowed application; detection of a device drop; detection of excessive device drops; breach of a geo-location fence; excessive data usage; excessive use of non-business applications; excessive battery drainage rate; low battery; low memory; low free storage; overheating; excessive speed; data being sent to prohibited/unknown destination(s); device usage/activity outside business hours; or a radio signal strength lower than a prescribed level and entry of an event by a user.

In some cases, the analyzing of the monitored data may include assigning an indicator to at least one of the monitored properties based on the analysis; and the displaying the monitored data may include displaying the monitored data based on the indicator for the related monitored property.

In some cases, the method may further include: determining if a monitoring mode is set as historical mode; and if so, communicating the monitoring mode to the plurality of mobile devices such that the receiving monitored data from the plurality of mobile devices includes receiving monitored data for a historical time period. In this case, the method may further include displaying a slider allowing a user to adjust the time displayed within the historical time period and the display displays the monitored properties for the adjusted time.

In some cases, the monitored data may include a list of running applications, and the automatically control mobile device settings may include shutting down one or more applications from the list of running applications.

In some cases, the analyzing may include determining if a battery level is below a predetermined threshold and the automatically control mobile device settings may include remotely controlling the mobile device to perform at least one of: dimming a mobile device display, shutting down applications, notifying a mobile device user to recharge or notifying a remote user or a helpdesk technician or administrator, wiping mobile device data, locking a mobile device, quarantining a mobile device, displaying a message on a mobile device, triggering the camera on a mobile device, making a sound on a mobile device, and flashing the screen of a mobile device.

In some cases, the monitored properties may be associated with applications running on the mobile device or files written by applications running on the mobile device.

In some cases, the method may further include: communicating at least a subset of the set of data monitors to a third party computer system; receiving monitored data associated with the monitored properties from the third party computer system based on the data monitor triggers; and analyzing the monitored data to display status information based on the monitored data.

According to another aspect herein, there is provided a system of data monitoring for mobile device management, the system including: a processor and a memory, wherein the memory includes computer readable code that, when executed on the processor cause the system to implement the following: an agent server configured to determine a set of data monitors, where each data monitor in the set comprises a monitored property and a data monitor trigger for the monitored property, wherein the agent server is configured to: communicate the set of data monitors to a plurality of mobile devices; receive monitored data associated with the monitored properties from the plurality of mobile devices based on the data monitor triggers; and analyze the monitored data to allow the display server to display status information based on the monitored data.

In some cases, the agent server may be configured to automatically control mobile device settings based on the monitored data.

In some cases, the display server may be configured to show at least some of the plurality of mobile devices displayed on a map or in a tabular form.

In some cases, the agent server may be further configured to: monitor for events received from the plurality of mobile devices; analyze the events to cause the display server to display the events together with the monitored data; and, optionally, automatically control mobile device settings or applications based on the events.

According to another aspect herein, there is provided a method for monitoring tracking tags, the method including: determining a set of data monitors for each tracking tag, where each data monitor in the set may include a monitored property and a data monitor trigger for the monitored property; receiving monitored data associated with the monitored properties from the plurality of tracking tags based on the data monitor triggers; and analyzing the monitored data to display status information based on the monitored data for tracking tags.

In some cases, the tracking tags can be configured to send location information, environmental data, or other relevant information directly to the monitoring system or to a tertiary system, with which the monitoring system exchanges information received from the tracking tags.

In some cases, the set of data monitors for each tracking tag is configured based on the specific capabilities and functionalities of the tag, such as its ability to provide location data or environmental sensor readings.

In some cases, the analysis of the monitored data includes integrating data from tracking tags with data from mobile devices and/or sites to provide a comprehensive view of the monitored environment.

In some cases, the analysis of the monitored data includes detecting anomalies or deviations in tag data to identify potential issues or security threats within the monitored environment.

In some cases, the method may further include: configuring tag-specific monitoring policies or rules based on the functionalities and deployment scenarios of each tag; applying the configured monitoring policies to the respective tags to ensure compliance and efficient monitoring.

In some cases, the monitoring system may be configured for tracking the movement and status of tags within the monitored environment in real-time or near real-time.

According to another aspect herein, there is provided a method for monitoring location-based sites for mobile device management, the method including: determining a set of data monitors for each site, where each data monitor in the set may include a monitored property and a data monitor trigger for the monitored property; communicating the set of data monitors to a plurality of sites; receiving monitored data associated with the monitored properties from the plurality of mobile devices and sites based on the data monitor triggers; and analyzing the monitored data to display status information based on the monitored data for sites.

In some cases, the set of data monitors for each site can be configured based on the specific activities or functions associated with the site, such as product distribution or general operations.

In some cases, each site can include a plurality of/multiple submonitors, each submonitor may represent a distinct area or function within the site, and each submonitor may have its own set of associated monitors.

In some cases, the data monitors/monitored properties associated with a site may include environmental factors, operational parameters, or security-related metrics specific to the activities conducted at the site.

In some cases, the monitored data received from sites is integrated with data from mobile devices and/or other external third party systems to provide a comprehensive view of the mobile device ecosystem within an organization.

In some cases, the analysis of the monitored data may include generating recommendations or alerts for optimizing operations or addressing potential issues on individual mobile devices, sites or external third-party systems.

In some cases, the method may further include: configuring site-specific monitoring policies or rules based on the activities or regulatory requirements associated with each site; and applying the configured monitoring policies to the respective sites to ensure compliance and efficient operations.

Other aspects and features of the embodiments of the system and method will become apparent to those ordinarily skilled in the art upon review of the following description of specific embodiments in conjunction with the accompanying figures.

### BRIEF DESCRIPTION OF THE FIGURES

Embodiments of the system and method will now be described, by way of example only, with reference to the attached Figures, wherein:

FIG. 1 is a schematic drawing of a system for data monitoring for mobile device management according to an embodiment herein;

FIG. 2 is an illustration of an example user interface displaying a map with mobile device locations;

FIG. 3A is an illustration of an example mobile device popup window;

FIG. 3B is another illustration of an example mobile device popup window;

FIG. 3C is another illustration of an example mobile device popup window;

FIG. 4 is an illustration of an example mobile device location indicator;

FIGS. 5A and 5B are illustrations of example historical sliders;

FIG. 6 illustrates an example configuration dialog window;

FIG. 7 illustrates an example view settings dialog window;

FIG. 8 illustrates an example edit topics dialog window;

FIGS. 9A and 9B illustrate another example data architecture for storing mobile device data; and

FIG. 10 is a flowchart of an embodiment of a method for data monitoring for mobile device management.

### DETAILED DESCRIPTION

The following description, with reference to the accompanying drawings, is provided to assist in understanding the example embodiments. The following description includes various specific details to assist in that understanding but these are to be regarded as merely examples. Accordingly, those of ordinary skill in the art will recognize that the various embodiments described herein and changes and modifications thereto, including the use of elements of one embodiment with elements of another embodiment, can be made without departing from the scope and spirit of the appended claims and their equivalents. In addition, descriptions of well-known functions and constructions may be omitted for clarity and conciseness.

The terms and words used in the following description and claims are not limited to their bibliographical meanings but are meant to be interpreted in context and used to enable a clear and consistent understanding.

Generally speaking, embodiments of the system and method herein provide for dynamic real-time and historical remote monitoring of mobile devices in a network. Mobile devices is intended to mean any mobile Internet of Things (IoT) device connected, or connectable to, a network including mobile phones, connected vehicles, tags, and the like. For example, device telemetry data can be retrieved from mobile devices and displayed on a map providing visual representations of data with the ability to drill down for further detail. The transmission of data is controlled. This can help limit issues with both data transmission and data storage.

In the following description, the following terms are used:

“Dynamic monitoring” refers to the use of a data monitoring structure that facilitates a flow of data from mobile devices to a server. The data monitoring structure makes use of a set of data monitors (sometimes called a data monitor set or monitor set), created by selecting one or more properties to be monitored. The data monitoring structure/monitor set is dynamic because users can update the data monitoring structure (via the monitor set) depending on the properties desired to be analyzed. Once a monitor set is created by a user, the monitor set can be stored on a server and/or can be sent to device agent software (“agents”) on the mobile devices using the data monitoring structure. Once the agent receives a monitor set, the agents can send data about the specified properties in the monitor set to a server or the like. Generally speaking, the mobile devices react to receiving a monitor set by sending data feeds for the monitored properties specified in the monitor set. The data feeds can be sent to the server using, for example, a subscription model, and can be displayed for a user on a console, browser or the like.

“Data monitor triggers” refers to another aspect of the data monitoring structure. In particular, a monitor set can also include specifications about rules/policies/circumstances/scheduling under which monitored properties in the monitor set are to be updated/sent. Data monitor triggers determine when data about monitored properties are to be collected and sent to the server. In some cases, the mobile device agent will send an initial data feed upon receiving a new monitor set, regardless of the schedule information specified. In some cases, the data monitor trigger may be adjusted automatically based on a status of the mobile device. Examples of data monitor triggers include: send data based on a specified amount/level of change from the previous value sent (i.e. significant change); send data back periodically, for example, every 1, 5, 10, 15, 20, 30 seconds or the like; send data that is outside of a predetermined threshold; or the like. Some examples of monitor sets with data monitor triggers include: send data about foreground applications (apps) and cellular signal strength when the foreground app changes or the signal strength changes by 10 or more percent; send signal strength, CPU, and memory every 5 seconds, or a combination of these. In some cases, a setting within the monitoring system or a monitor set may also specify that historical data of a predetermined time in the past is to be sent so that a user can monitor or review earlier activity for the properties in the monitor set. These data monitor triggers can be adjusted periodically or in real time based on other or related policies, rules, regulations, or the like.

“Flags” and “Events” refer generally to data items that occur outside of the data monitor sets and are typically related to larger changes in properties or information related to other changes for the mobile device or the user that will have an impact on the operation of the mobile device or the user's ability to continue to proceed in an ordinary manner. Generally speaking, flags are generated automatically and are related to a particular mobile device whereas events are generated by a user and may impact more than one mobile device but this is not a requirement. Examples of flags/events may include: a drop in battery level of more than a predetermined threshold; a user entering information about an event, such as information about a flat tire; a mobile device drop; a mobile device moving at excessive speed; a mobile device moving outside of a geofenced area; or the like.

Generally speaking, data received at the server can be displayed immediately or stored/cached so that it can be displayed on demand. In some cases, data may not be stored at the server and data is only received/displayed when required or only saved on the server in particular circumstances, such as based on an event or input from a user of the server or the like. As described further below, received data feeds (whether real-time or historical) can be displayed on a map (outdoor or indoor), graph, chart or the like, as selected by a user. The display can also include an indicator such as a visual color coding intended to summarize the status/health of each device using color coded markers for device health overall and/or specific indicators such as signal strength, and the like. Other indicators may include sound(s), flashing, vibrating, or the like. Depending on the format of the display, detailed information for each device can be displayed by selecting a specific device via, for example, the user interface and drilling down into additional data.

As noted above, the monitor set or a separate request may include a request for historical information. As such, the system can additionally display historical data about a device or set of devices, which can help provide indicators about the status/health of individual devices, the network in a particular area, or the like. The historical period that is displayed can generally be any period from the latest collected real-time data back to a predetermined time to which the device maintains data. The predetermined historical period can be determined based on factors such as the timing of the initial collection of data, the bandwidth/communication strategy in place, the data storage approach with regard to how long the data is maintained after collection (based on storage capacity, amount of data collected, and the like), and related factors. The historical time period may be set as appropriate including, for example, 10 minutes, 30 minutes, 60 minutes, several hours, one or more days, or the like. Again, depending on the bandwidth/communication strategy, storage approach, and the like the system may collect and provide historical data for all or a subset of monitorable data values, for example, signal strength, memory, available storage, and the like.

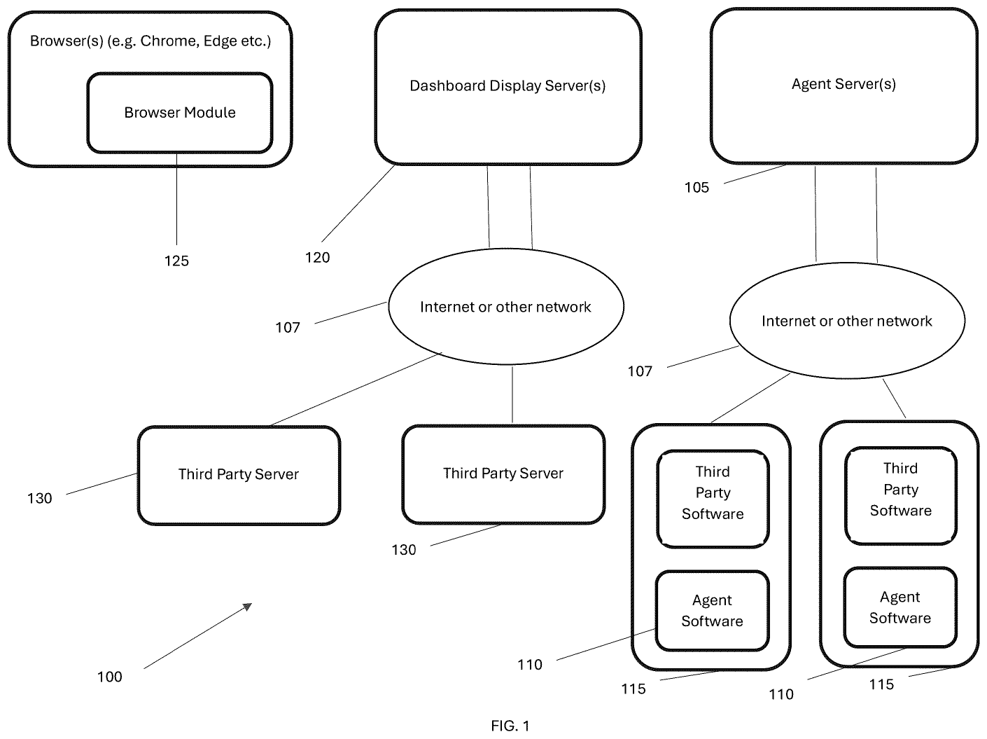

FIG. 1 is a schematic diagram of an embodiment of a system 100 for mobile device management. The system 100 includes an agent server 105 that connects via a network 107 with device agent modules 110 provided to each of the mobile devices 115 intended to be monitored and managed. The system may also include a dashboard display server 120 and a browser module 125, used to provide a user interface for the system. In some cases, the browser module 125 may be a separate software application or may be configured to operate within a conventional internet browser (as shown in FIG. 1). It will be understood that the display server 120 may be a part of the agent server 105 or vice versa. Further, the agent server 105 and display server 120 may be distributed servers in the sense that the functionality may be distributed over multiple servers, instances of servers, or the like. A distributed arrangement can allow for scalability to support a larger number of mobile devices. In any event, the system 100 will also include one or more processors and memories associated with the agent server and the display server that include computer readable code for executing the functions of the system 100.

Generally speaking, the agent server (AS) 105 is configured to send commands to mobile devices 115 as well as receive information from mobile devices 115, generally via the device agent modules 110 that are installed on the mobile devices 115. The AS 105 can forward information received from device agent modules to the dashboard display server or can save received information into a database or the like. The AS sends commands to devices with regard to monitor sets for data monitoring so that the device agent modules can send the monitor data to the AS.

The dashboard display server (DDS) 120 is configured to communicate with the AS to receive data and with the browser module to display information received from mobile devices. The DDS can also drive the browser module to allow users to enter monitor sets that are used by device agent modules to define data collection behavior. The DDS also acts as a conduit to shuttle information between devices (via, for example, the AS) and the browser module. The DDS may also connect with third party servers 130 to obtain monitored data, flags, events, or the like that is supplied by the third party, to obtain device information such as, for example, expected battery life or the like, to allow for custom user settings, or the like.

The device agent module 110 is installed on the mobile devices and is configured for communication with the agent server. The device agent module 110 receives a monitor set from the agent server and acts on the monitor set to send monitored data to the agent server. As an example, each monitor set can be broken down into a series of commands that identify what monitored data is to be sent to the agent server. As noted above, in some cases, the monitor set may also include information about when monitored data is to be sent (“data scheduling” as discussed above). Examples of commands from a monitor set may include: Example 1-send location information if the device moves more than a 100 meters from previous point; or Example 2-send location information every 5 seconds. Commands may also be specified by a set or subset, possibly by using a wildcard term or the like, for example—send all data types. As noted above, the monitor set may change based on the status of the mobile device, for example, the monitor set may be configured to change to send location information every 10 seconds when within the head office geofence.

As discussed herein, the monitored properties may include various types of properties available for a mobile device, such as, for example, CPU usage, memory available/consumed, storage available/consumed, signal strength (such as WiFi/Cellular/Bluetooth or some combination), battery discharge/health information, applications (apps) being used or running, and the like. The monitored properties may also include information related to the user/use of the mobile device or the like, including business information/status or the like. For example, if the mobile device is provided to a refrigerated truck or the like, the monitored data may include a temperature of the storage area of the truck, or, if the mobile device is provided to an ambulance, the monitored data may include if the ambulance has a patient and/or the status (i.e. critical, non-critical) of the patient, or, if the mobile device if provided to a service truck, the monitored data may be a number of replacement parts in the truck. In particular, the ability to monitor apps being used or running can provide additional insight to information technology support issues being experienced, such as intermittent poor performance. In some cases, the apps being used on a mobile device may be presented via the DDS using a different color, format, icon, or the like and the apps may be differentiated between foreground apps and background apps. Further, the monitored properties may be associated with an app on the mobile device, a file written by an app on the mobile device, or the like. This allows the system to obtain additional data/information from the mobile device, including data/information from third party sources or the like. It will be understood that the system may include a configuration module to allow for custom monitored properties, such as that noted above related to business properties, to be specified depending on the end users' requirements.

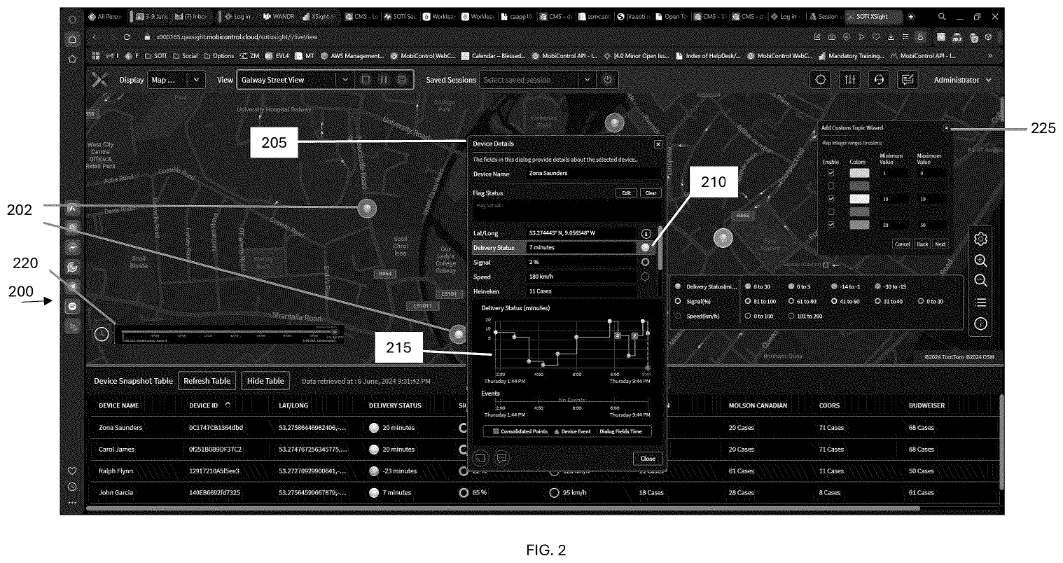

The browser module 125 can provide a user interface (UI) allowing users to display information about mobile device(s) received from the DDS. The information (i.e. mobile devices and data values) can be presented in a geographic view, for example, on a map (outdoor or indoor), floorplan, or the like, such that the mobile device can be monitored as it moves within the geographic view. The geographic view may include indoor mapping details and/or outdoor mapping. Information about mobile device(s) could alternatively or also be provided in other formats such as a dashboard, in a table, or the like. FIG. 2 is an illustration of a UI 200 displaying a geographic view (map) with mobile device location indicators 202 and other data. The geographic view may be a map (outdoor or indoor), a satellite view, a video stream, or the like or a combination thereof. It will be understood that the set of mobile devices being monitored may or may not be connected with a geographic view. The filter used to select the mobile devices being monitored may include the geographic view or may include a larger set of mobile devices that are just displayed based on whether or not a mobile device is in the area covered by the geographic view even though mobile devices outside of the geographic view may still be sending data according to a monitor set.

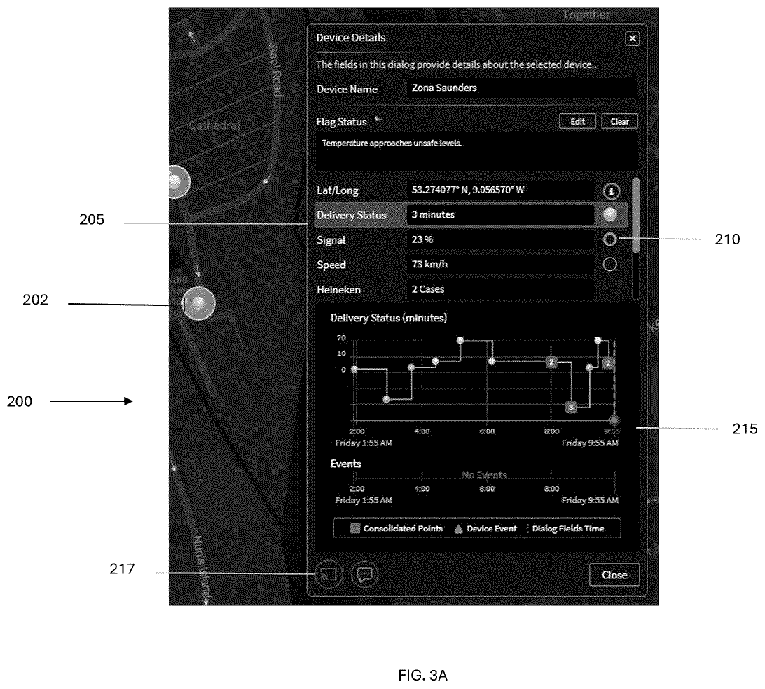

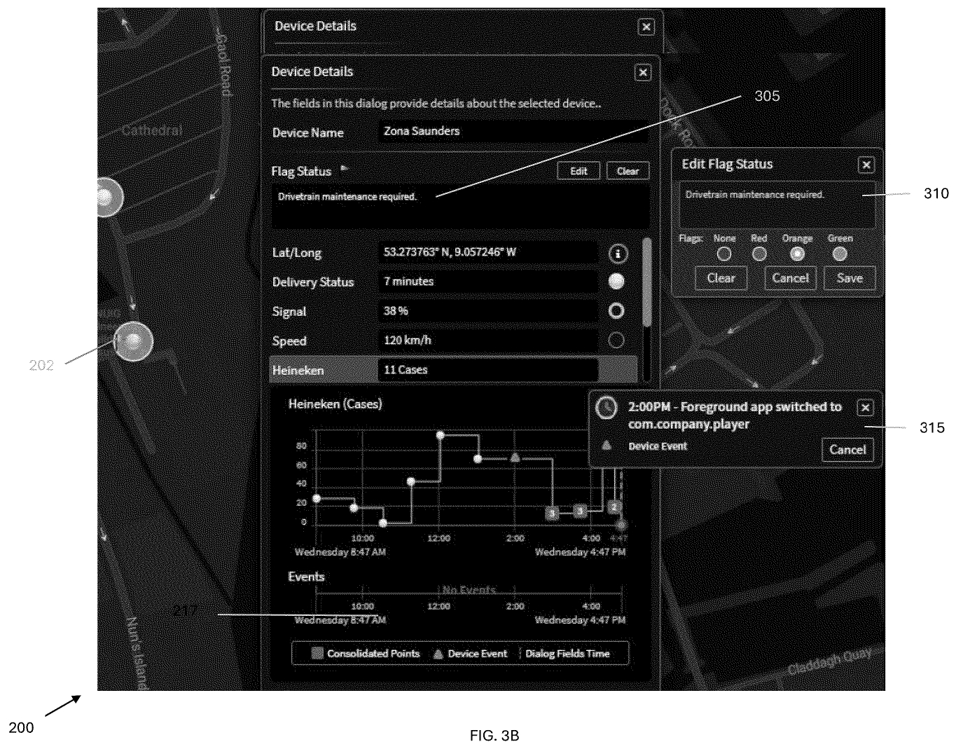

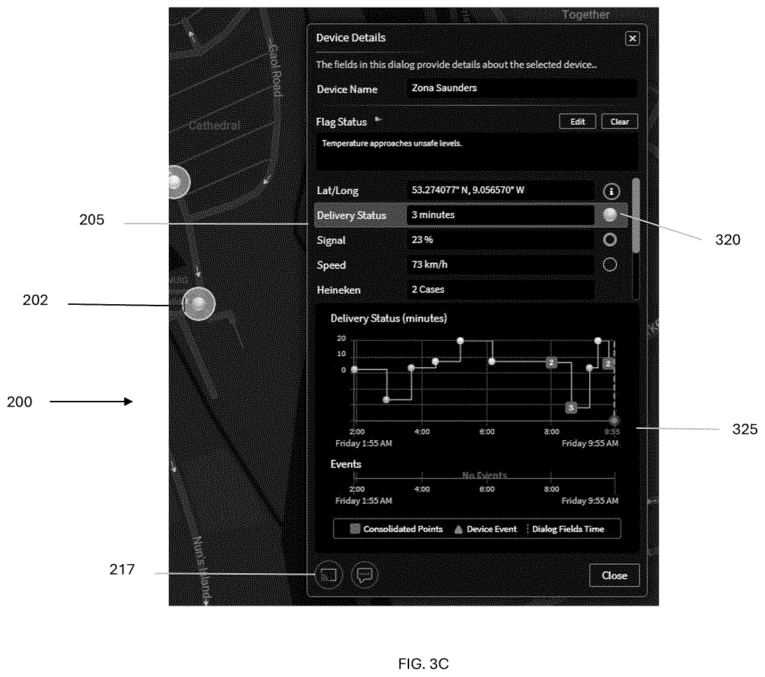

In some cases, data for the monitored properties for a particular device can be displayed via a device popup window 205, which opens when the particular mobile device location indicator 202 is selected. FIG. 3A is an illustration of an example device popup window 205. Within the device popup window 205, a user can also select a particular monitored property (e.g. CPU) 210. As shown in this example, the device popup window 205 may include a historical window view 215 for the selected monitored property. For example, in FIG. 3A there is a historical window view 215 for the selected CPU property 210. As shown in FIG. 3A, the historical window view 215 may also include a display of events, in this case, illustrated as a triangle. Events may include events that are not otherwise monitored and, in some cases, may have an impact on the device itself, on a group of devices or on the operation of the device or group of devices such as, for example, a device drop, a foreground app change, device put on/off charger, low/no signal, failure of a group of mobile devices, a storm in the area, or the like. FIG. 3A also illustrates live tools buttons 217 that can allow an IT support worker to interact directly with a mobile device or mobile device user, for example, by taking remote control of the mobile device or live/voice chatting with the mobile device user, or the like.

FIG. 3B is an illustration of another example device popup window 205. In this example, there is a flag and a flag status field 305, indicating the meaning of the flag. FIG. 3B also indicates a flag status edit window 310 that allows for changes to the flag and flag status. In FIG. 3B, an example of an event is also shown in the historical window view as highlighted and further information about the event can be displayed in an event window 315.

FIG. 3C is an illustration of another example device popup window 205. In this example, there is a delivery status field 320 and also a delivery status window 325 (a type of event window 315) illustrating the delivery status over time.

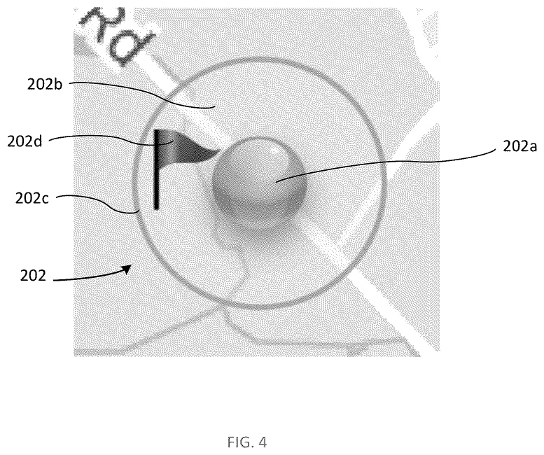

FIG. 4 is a more detailed view of an example mobile device location indicator 202. As shown, each mobile device location indicator 202 can include indicators such as a dot 202a, a disk 202b around the dot 202a, a halo 202c around the disk 202b, and a flag 202d. Each of the data indicators can indicate a status of a monitored property for the mobile device. It will be understood that other data indicators may also be added, for example, the disk may be divided into portions, such as quadrants, with each portion representing a different monitored property or the like. As noted above, additional information for the monitored data, including flags, may be viewed by selecting the mobile device location indicator 202 and opening the device popup window 205. It will be understood that selecting may be done by moving a cursor over, by clicking a mouse button, or the like. In some cases, flags may be used for particular situations of interest, such as, for example, inventory running low, truck engine overheating, requesting help/service, or the like.

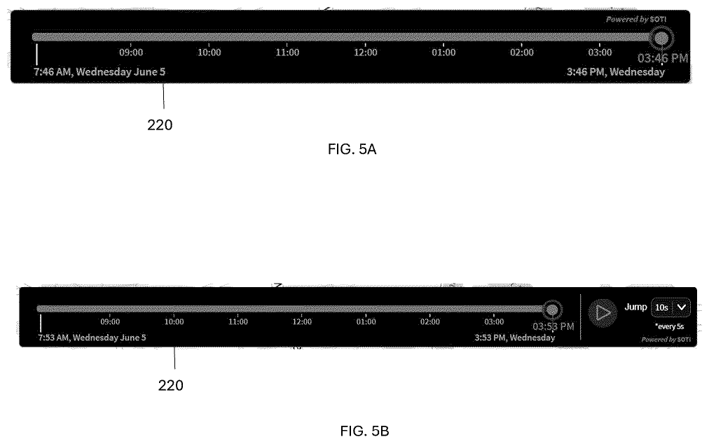

In FIG. 2, there is also a historical slider 220, shown in more detail in two examples in FIGS. 5A and 5B, which allows a user to change the map view to show mobile device location indicators 202 of the mobile devices as they were at a point in time in a historical period rather than in live view. Each mobile device location indicator 202 on the display will update to reflect the state of the mobile device at the selected time in the historical period. Similarly, data that can be displayed for the mobile devices (via, for example, the device popup window 205), will adjust based on the selected time in the historical period. This allows visual representation of historical information for mobile devices on the map view, rather than for just a single mobile device as illustrated in the device popup window 205 from FIG. 3. In these examples, the historical slider 220 may include shading on the timeline to indicate activity in the monitored data, events, or the like.

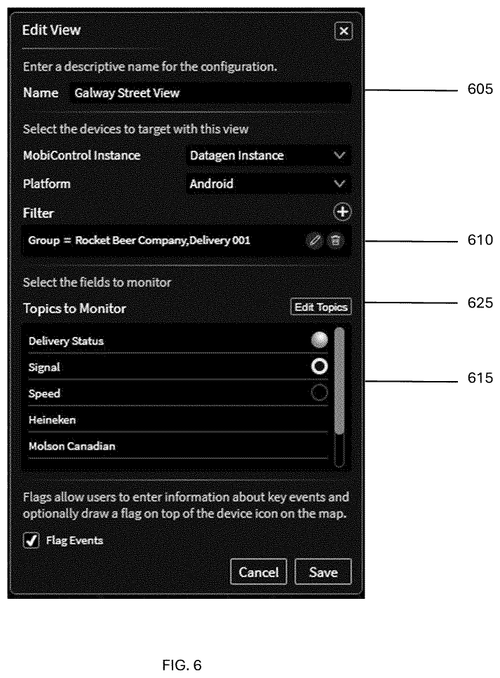

In FIG. 2, there is also a settings/configuration window 225, shown in more detail in FIG. 6. The settings/configuration window 225 allows a user to edit/interact with the browser module to configure monitor sets, filters and/or the display. When a user configures the data monitoring structure, the monitor set (monitored properties and data collection triggers) is passed to the device agent modules to specify the monitored properties/data to be collected and made available to the server. As noted herein, the monitor set may include data collection triggers, which are conditions under which device agent modules send data (e.g. significant change, based on time, or the like). In FIG. 6, the monitor set can be edited by selecting to “Edit Topics”. Topics or Fields are other terms that can be used for monitored properties. The browser module can also allow a user to switch between historical mode (i.e. by using the historical slider 220) and live monitoring mode (i.e. live view is selected), as described further below.

FIG. 6 illustrates an example settings/configuration window 225. In using the system, a user may first create/define a filter to identify the set of devices to be monitored/displayed or may, alternatively, rely on a default filter. As illustrated, the “Name” field 605 allows a user to either use a “default” filter, select a filter, or to name a configured filter and save it for future use. The “Filter” field 610 shows the parameters of the current filter. Filters may be saved either on a server or locally at a browser. For example, the settings/configuration window 225 may allow a user to select parameters such as a device group, particular device manufacturers, device models, if the devices are GPS enabled, and any of various parameters that may be of interest. An end user may also be able to customize the parameters for their particular requirements. Other appropriate segmentation/parameter options may be provided with the goal of allowing a user to focus in on a set or subset of devices that they are interested in monitoring/displaying. In this case, the settings/configuration window 225 also has a “Fields to Monitor” area 615 that illustrates the monitor set (i.e. monitored properties and/or data collection triggers) to be monitored and displayed. The fields to monitor area can also allow a user to select and adjust a range of values for the indicators, in this case a color coded display. In this example, a user can adjust sliders to determine at which level the color is green, blue, yellow, orange, or red. The user can also select the format of the display on the geographical map or indoor map; in this case, the overall property is the dot, the signal property is the halo, and the CPU property is the ring. In this case, the memory and other values can also be monitored and viewed in the device popup window 205.

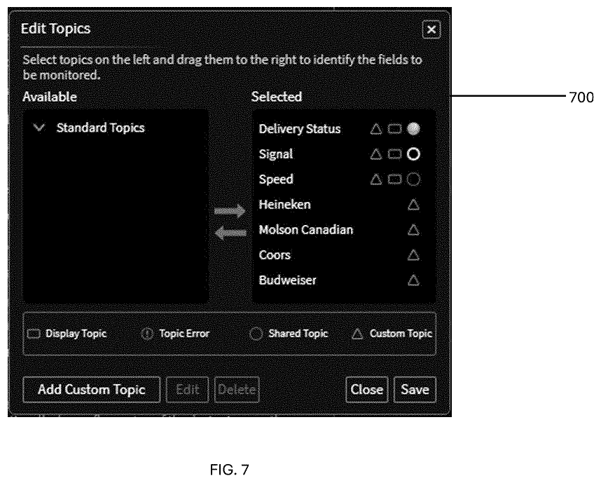

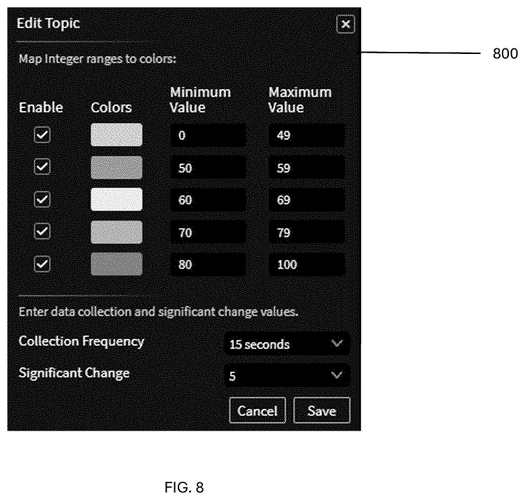

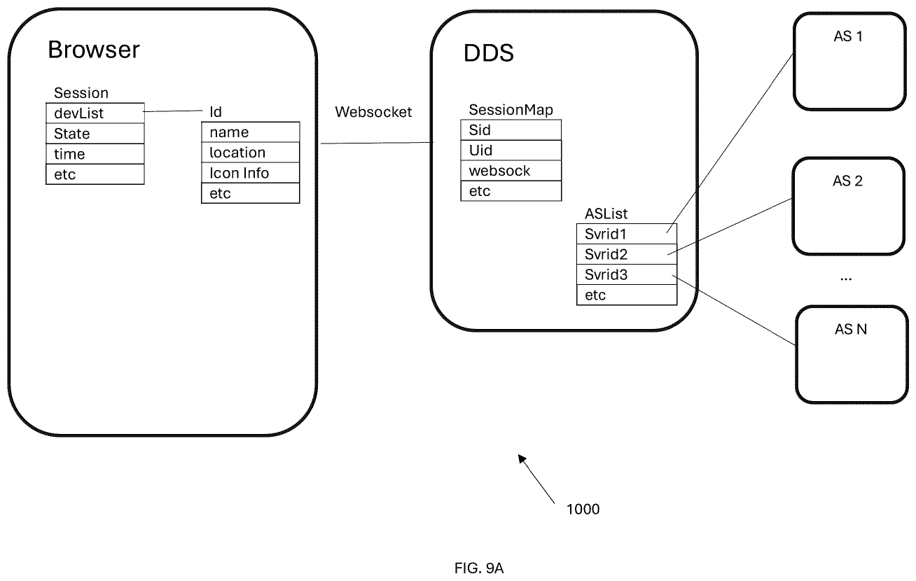

FIG. 7 illustrates a View Settings window 700 that is opened by selecting a “Configure View Settings” button 620 in the settings/configuration window 225. The view settings window 700 allows a user to select/adjust the information displayed in the settings/configuration window 225 and thereby, the filters to be used for selection of a set or sub-set of devices (sometimes referred to as a device grouping). FIG. 8 illustrates an edit topics window 800 that is opened by selecting an “Edit Topics” button 625 in the settings/configuration window 225. The view settings window 800 allows a user to select/adjust the collection/display parameters of the data to be monitored, that is, a monitor set.

As noted above, the system 100 can be configured to allow at least two display modes, live monitoring mode and historical mode. In either mode, users have the ability to configure color coding for the state of monitored data values/variables. Once configured, either in a default mode or by a user, the system automatically assigns indicators, such as color coding, such that the user can monitor mobile devices, for example, visually.

In live monitoring mode, the system displays the mobile devices on, for example, a map/floor plan as the mobile devices move and displays data for monitored properties as the properties change in real-time. This can be useful for an organization to be able to watch and understand the live operation of their business. Since devices are remote, this type of real-time analysis allows for detecting or resolving problems as early as possible. As an example, a mobile device user may complain that, at seemingly random times, business apps do not work. With live monitoring, a user can see that, when a device moves into a low signal area, problems occur and when they move out of that area the business apps work as expected. As another example, application performance may be poor for all devices having poor battery health below a certain threshold. In yet another example, upon detection of a location change into or outside a specific area (identified by a breach of a geofence or the like), tracking of device location can be activated combined with removal of any sensitive information form the device. Alternatively, based on received telemetry data, certain problems can be diagnosed such as failures of a specific build of a particular application, possibly on a specific version of device firmware, so the impacted version of the software can then be blocked from being deployed on susceptible devices.

The second mode is historical monitoring mode. In historical monitoring mode, a window of historical data can be made available for display so that a user can look back in time to understand a situation that caused a particular problem to occur. This type of visualization can be useful in solving a range of technical and business problems. As an example, a mobile device user may complain that a particular app crashed at 2 pm. Using the historical monitoring mode, a user can adjust the historical slider 220 to review historical data at 2 pm and may notice that at 2 pm there was a spike in memory consumption caused by secondary apps consuming too much memory. It can be presumed that the spike in memory consumption by the secondary apps caused the business app to crash or further testing can be conducted. In either case, a potential solution to this problem could be to blacklist this secondary apps that caused the memory spike.

In another example, historical monitoring mode can be used to review past historical monitoring data from a multitude of mobile devices in order to plan activities and budgets for predictive maintenance such as device battery replacements. Further, such historical information can be used to proactively adjust and configure network capacity at specific locations or networks. In another example, historical data can be used to assess and evaluate performance of specific process participants or process stages, such as delivery timelines, speed of processing items or artifacts of potential issues with a mobile user, such as, for example, dangerous or aggressive driving.

In some cases, the system may instruct the set of mobile devices to save or send to the server for saving a predetermined time period of data so that the data can be played back at a later date as if it were being received in historical mode.

The agent server, device agent module and browser module can be configured to include several data monitoring structures to facilitate operation of embodiments of the system and method herein. In an embodiment of a data structure/architecture 900, example data monitoring structures may include:
(a) devCache—this data monitoring structure is a cache of historical data for each mobile device. This data is generally received from mobile devices but may be supplemented by external data that is accessed by the system, such as, for example, battery life information from a manufacturer or the like. In this case, each node of the data monitoring structure may be a list for a particular mobile device and represent the state of the device at a particular point in a live situation or within a historical window that is maintained by the system. The “time” variable in this structure identifies the time at which the mobile device data was recorded.
(b) curMonitor—this data monitoring structure contains the current monitor set that will be deployed to mobile devices to enable/continue monitoring. Table 1 illustrates an example of the curMonitor data monitoring structure. In this example, the data monitoring structure includes a list of properties to be monitored and the data monitoring trigger (e.g. criteria that determines if data for the property is to be sent) required to trigger mobile devices to send data.

TABLE 1

| Variable Name | signifChange |
|---|---|
| memActual | Send on 5% change |
| storageActual | Send on 5% change |
| cpu | Send on 5% change |
| signal | Send on 3% change |
| appList | Send on change |
| forgApp | Send on change |
| battery | Send on 1% change |

As described above, users can modify the monitor set using the browser module via the agent server. The system may be preloaded with a default monitor set to be used on initiation. Monitor sets may also be saved and retrieved when needed.

The use of efficient data monitoring structures and control over the monitor set for when data is updated provides for a reduced impact on bandwidth by reducing the amount of data being transmitted. Having a data monitoring structure that only retrieves data for monitored properties from mobile devices when needed also reduces the amount of data storage needed at the server end. This is unlike conventional technologies which generally involve either too much data, using too much bandwidth or storage, or too little data, which are not as useful for diagnosing issues that are occurring in the mobile devices being managed.

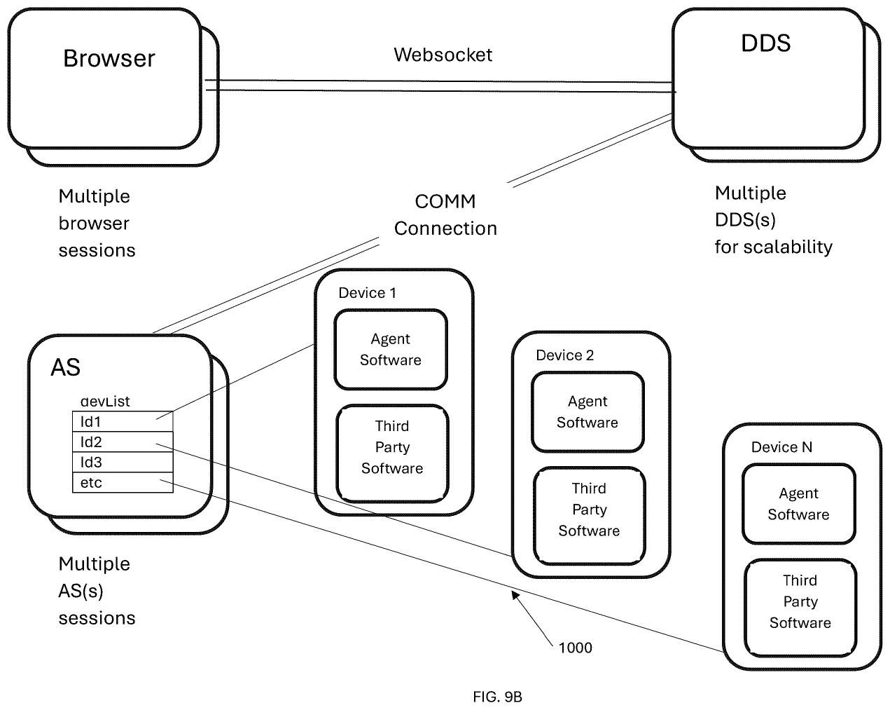

FIGS. 9A and 9B illustrate another embodiment of a data architecture 1000. This embodiment is similar to that in FIG. 1. As illustrated in FIG. 9A, the data architecture includes a browser data monitoring structure including a field for browser devList that is used by the browser module (or multiple browser modules) to cache enough information to provide responsive service to the end user, but yet minimize the browser memory footprint such that a large amount of devices can be supported. This structure allows more detailed information about a mobile device to be obtained in real time. For example, a display server (similar to the DDS above) may generate a real time request to an agent server (similar to the AS above) for a device, for example by using an AS svrId for the device). The display server (DDS) data monitoring structure can also include a DDS sessionMap, which is a data monitoring structure used to manage live view (LV) sessions between browsers and a particular DDS server. The DDS sessionMap allows a DDS to support multiple LV sessions with browsers (i.e. multiple clients), and also allows messages between browsers and devices to be routed based on the session id (Sid). As further illustrated in FIG. 9B, each display server (DDS) communicates with one or more agent servers (AS), which in turn communicate with one or more mobile devices (dev1, dev2, etc.). Each AS manages a list of active LV sessions and the devices that are part of each session. In this way a DDS can simply send the sessId of a session to be terminated, the AS will, in turn, contact each device in the session and finally delete the session itself.

Within this architecture, starting a live view (LV) session can involve the following steps: Browser generates a unique session id (GUID); Browser opens a connection, for example, a web socket connection, to the DDS server; Browser sends a LVStart (sessId, filterId) message on web socket; DDS server caches the sessId in the sessMap table; DDS executes call to a Services server to get list of “connected” devices that match filter monitor, an example result: svrId1: devIdList1, svrId2: devIdList2, . . . ; To each AS server in list, DDS sends a LVStart (sessId, devList, displayTopics) message; DDS caches the AS server list associating with LV session; Each receiving DDS sends a LVStart (sessId, dispTopics) message to each device to initiate LV; Each device responds with LVFeed (SessId, dispValues) for each monitored property in a monitor set, and sends additional LVFeed messages when predetermined changes (e.g. data monitoring triggers) occur to monitored properties.

Further, stopping an LV session can include the following steps: Browser sends LVStop (sessId) message on web socket; DDS receives the message and sends immediate response to browser; DDS iterates through AS's associated with session, sending an LVStop (sessId) message to each AS; and each AS then: Looks up the sessId in its LVSessMap structure; Iterates through the devices associated with session; Sends LVStop (sessId) to each device in the session; and; Removes sessId from LVSessMap structure.

Generally speaking, the data architecture 1000 is structured such that, once an LV session has been started, devices initially send in the latest monitored data for each monitored property, and after that only send when there is a relevant change (i.e. based on the data monitor trigger) to a monitored property. The browser only caches the received data value for each monitored property with a goal of minimizing the memory footprint related to each device. Thereafter, when a user clicks on a mobile device icon on the map, a dialog showing the details for the device can be displayed by taking the following steps: Browser retrieves the AS server and device id from its cache, and sends a LVGetTimeslice (sessId, devID, svrId) to the connected DDS server via the websocket; the receiving DDS then sends the message to the target AS; the receiving AS will then lookup the device by its device id, and send the message to the device; the device will then create a LVTimeslice message that contains data for properties in the time slice and send the message back; the message will arrive back at the browser and the browser will parse through the data and populate the Device Details dialog. If a mobile device that is in an active LV session disconnects, the device can be marked as disconnected on the map. Similarly, if a device comes online in the map area while a LV session is in progress, the device can be added to the session automatically.

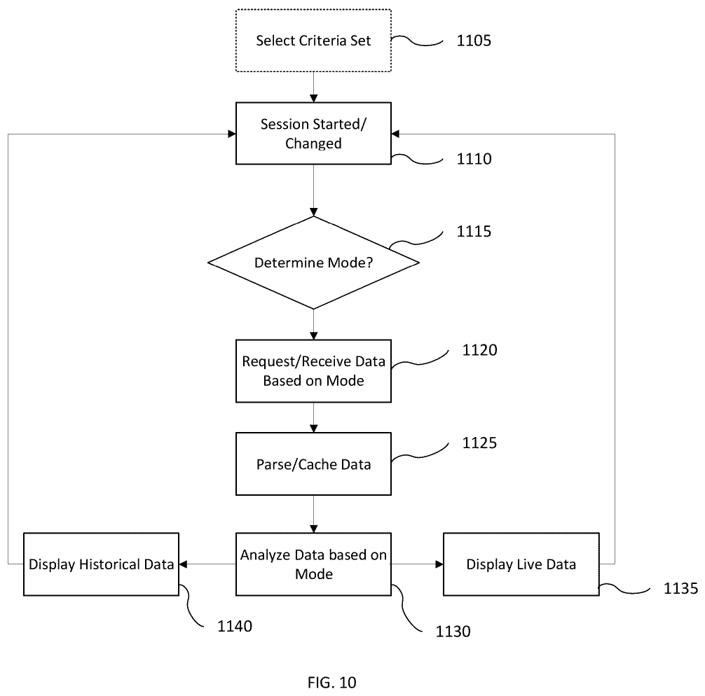

FIG. 10 is a flowchart 1100 of an embodiment of a method for data monitoring of mobile devices. At 1105, a user selects a monitor set for data monitoring and the monitor set can be saved for future use. In some cases, there may be a default monitor set already provided by the system or a user may have configured a monitor set in advance. At 1110, the system determines that a session (or example, live view or historical) has started. The start of a session will typically begin with a predetermined set of devices to be monitored, for example, the same set of devices from a previous session, a default set of devices or the like and/or allow the user to select the set of devices, using filters or the like. In some cases, the set of devices being monitored may be referred to as a device grouping. Filters may include, for example, brand of device, model of device, customer name, corporate division, user customizable filter, location on a map, or the like. As one example, the set of devices may be selected based on a geographic map of predetermined size/area including mobile devices within the geographic area. Further, within a session, a user may select/determine/adjust, for example, a geographic area, a subset of mobile devices, select a monitor set, or the like. At 1115, the system can determine if the session is a live view session or historical session (i.e. live view mode or historical mode). Normally a session will begin in a live view mode and will be changed to historical mode by a user accessing the historical slider. As such, the monitoring for the mode can be operational while the method is proceeding. At 1120, the system then requests/receives data from the mobile devices according to the monitor set and based on the determined mode. At 1125, the system parses and caches the data received from the mobile devices. At 1130, the parsed data is analyzed for display on the user interface (UI) based on the selected mode. If the system is in live monitoring mode, live/current data is displayed on the UI at 1135. If the system is in historical mode, the selected historical data is displayed on the UI at 1140. As noted above, in some cases, the system may also be configured to save a historical period of data or instruct the mobile device to save a historical period of data for review at a later date. As will be understood and as noted, the user may interact with the UI to change a geographic area, change a subset of mobile devices, change items within a monitor set, or the like and the system recognizes the change (at 1110) and the process repeats. The display allows a user to review the data for reported or unreported issues.

As described herein, analyzing the data may include applying an indicator such as color coding based on pre-set or default values, for example, setting a color value of a dot, halo, or ring based on the color coding, and adjusting the color coding or color value for the dot, halo, or ring based on data received. Analyzing may further include notifying a user of any significant changes for mobile devices based on predetermined thresholds, notifying a user based on a number of data properties moving to a poorer performance level (typically indicated by red color coding), or the like. Analyzing may also include proactively triggering actions within other systems, such as shutting down an application, sending an email, making an API call or triggering a webhook.

In some embodiments of the system and method above, a user can select a time slice to save either during live view mode or historical mode. When selected, the system will save and store the data received/cached for the present time slice on, for example, a display server, so that the time slice can be called up again in a similar way to the request/receive data step but the data is requested/received from the storage location. In this way, a user can replay a previous time period of data to assist in the diagnosis of issues or the like.

It will be understood that similar technical approaches as those above can be used with regard to connected sites (i.e. fixed locations) within a business's operations. In some embodiments, there may be a method for monitoring location-based sites for mobile device management that includes: determining a set of data monitors for each site, where each data monitor in the set comprises a monitored property and a data monitor trigger for the monitored property; communicating the set of data monitors to a plurality of sites; receiving monitored data associated with the monitored properties from the plurality of mobile devices and sites based on the data monitor triggers; and analyzing the monitored data to display status information based on the monitored data for sites. In particular, the set of data monitors for each site can be configured based on the specific activities or functions associated with the site, such as product distribution or general operations. Further, each site may have multiple submonitors, each submonitor representing a distinct area or function within the site, and each submonitor having its own set of associated monitors. For example, the monitored properties associated with a site may include environmental factors, operational parameters, or security-related metrics specific to the activities conducted at the site. In this case, the monitored data received from sites can be integrated with data from mobile devices and third party systems (collected as described above) to provide a comprehensive view of the mobile device ecosystem within an organization. In some cases, the analysis of the monitored data includes generating recommendations or alerts for optimizing operations or addressing potential issues on individual mobile devices, sites or third-party systems. Further, the method may further include: configuring site-specific monitoring policies or rules based on the activities or regulatory requirements associated with each site; and applying the configured monitoring policies to the respective sites to check for compliance and efficient operations.

In the preceding description, for purposes of explanation, numerous details are set forth in order to provide a thorough understanding of the embodiments herein. However, it will be apparent to one skilled in the art that these specific details may not be required. In other instances, well-known structures or circuits may be shown in block diagram form in order not to obscure the overall system or method. For example, specific details are not provided as to whether the embodiments described herein are implemented as a software routine, hardware circuit, firmware, or a combination thereof.

Embodiments can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment. Those of ordinary skill in the art will appreciate that other instructions and operations necessary to implement the described embodiments can also be stored on the machine-readable medium. Software running from the machine-readable medium can interface with circuitry to perform the described tasks.

The above-described embodiments are intended to be examples only. Elements of one embodiment may be used with other embodiments and not all elements may be required in each embodiment. Alterations, modifications and variations can be effected to the particular embodiments by those of skill in the art without departing from the scope of the invention, which is defined solely by the claims appended hereto.

What is claimed is:

1. A method of data monitoring for mobile device management, the method comprising:
determining a set of data monitors, where each data monitor in the set comprises a monitored property and a data monitor trigger for the monitored property;
communicating the set of data monitors to a plurality of mobile devices;
receiving monitored data associated with the monitored properties from the plurality of mobile devices based on the data monitor triggers; and
analyzing the monitored data to display status information based on the monitored data.

2. A method according to claim 1, further comprising: automatically controlling mobile device settings based on the monitored data.

3. A method according to claim 1, further comprising selecting a subset of the plurality of mobile devices to be monitored.

4. A method according to claim 1, further comprising showing at least some of the plurality of mobile devices displayed on a map or in a tabular form.

5. A method according to claim 4, wherein the displayed map comprises an indoor or an outdoor map.

6. A method according to claim 1, wherein the data monitor trigger comprises determining if the monitored data for the monitored property has changed more than a configured threshold value or beyond a configured threshold as defined by a set of rules.

7. A method according to claim 6, wherein the configured threshold value or configured threshold as defined by a set of rules is adapted based on a status of the mobile device.

8. A method according to claim 1, further comprising:
monitoring for events received from the plurality of mobile devices; and
analyzing the events to:
display the events together with the monitored data; and optionally,
automatically control mobile device settings or applications based on the events.

9. A method according to claim 8, wherein the events comprise at least one of: opening of a disallowed application; detection of a device drop; detection of excessive device drops; breach of a geo-location fence; excessive data usage; excessive use of non-business applications; excessive battery drainage rate; low battery; low memory; low free storage; overheating; excessive speed; data being sent to prohibited/unknown destination(s); device usage/activity outside business hours; or a radio signal strength lower than a prescribed level and entry of an event by a user.

10. A method according to claim 1, wherein:
the analyzing of the monitored data comprises assigning an indicator to at least one of the monitored properties based on the analysis; and
the displaying the monitored data comprises displaying the monitored data based on the indicator for the related monitored property.

11. A method according to claim 1, further comprising:
determining if a monitoring mode is set as historical mode; and
if so, communicating the monitoring mode to the plurality of mobile devices such that the receiving monitored data from the plurality of mobile devices comprises receiving monitored data for a historical time period.

12. A method according to claim 11, wherein the method further comprises displaying a slider allowing a user to adjust the time displayed within the historical time period and the display the monitored properties comprises displaying the monitored properties for the adjusted time.

13. A method according to claim 2, wherein the monitored data comprises a list of running applications, and the automatically control mobile device settings comprises shutting down one or more applications from the list of running applications.

14. A method according to claim 2, wherein the analyzing comprises determining if a battery level is below a predetermined threshold and the automatically control mobile device settings comprises remotely controlling the mobile device to perform at least one of: dimming a mobile device display, shutting down applications, notifying a mobile device user to recharge or notifying a remote user or a helpdesk technician or administrator, wiping mobile device data, locking a mobile device, quarantining a mobile device, displaying a message on a mobile device, triggering the camera on a mobile device, making a sound on a mobile device, and flashing the screen of a mobile device.

15. A method according to claim 1, wherein the monitored properties may be associated with applications running on the mobile device or files written by applications running on the mobile device.

16. A method according to claim 1, further comprising:
communicating at least a subset of the set of data monitors to a third party computer system;
receiving monitored data associated with the monitored properties from the third party computer system based on the data monitor triggers; and
analyzing the monitored data to display status information based on the monitored data.

17. A system of data monitoring for mobile device management, the system comprising:
a processor and a memory, wherein the memory includes computer readable code that, when executed on the processor cause the system to implement the following:
an agent server configured to determine a set of data monitors, where each data monitor in the set comprises a monitored property and a data monitor trigger for the monitored property,
wherein the agent server is configured to:
communicate the set of data monitors to a plurality of mobile devices;
receive monitored data associated with the monitored properties from the plurality of mobile devices based on the data monitor triggers; and
analyze the monitored data to allow the display server to display status information based on the monitored data.

18. A system according to claim 17, wherein the agent server further automatically controls mobile device settings based on the monitored data.

19. A system according to claim 17, wherein the display server is configured to show at least some of the plurality of mobile devices displayed on a map or in a tabular form.

20. A system according to claim 17, wherein the agent server is further configured to: monitor for events received from the plurality of mobile devices; and analyze the events to cause the display server to display the events together with the monitored data; and optionally, automatically control mobile device settings or applications based on the events.
